(19) United States
(12) Patent Application Publication
(10) Pub. No.: US 2014/0261966 A1
(43) Pub. Date: Sep. 18, 2014

(54) PNEUMATIC VEHICLE TIRE WITH IMPROVED IMBALANCE

(71) Applicants: CONTINENTAL REIFEN DEUTSCHLAND GMBH, Hannover (DE); HENKEL AG & CO. KGAA, Dusseldorf (DE)

(72) Inventors: Thomas MÜLLER-WILKE, Lauenhagen (DE); Teodoro NUNO, Hannover (DE); Mathias MÜLLER, Weisenheim a.S. (DE); Oliver KRÖHL, Koln (DE); Michael GRAF, Lambsheim (DE); Ludger RECKERS, Nordstemmen (DE)

(21) Appl. No.: 14/290,472

(22) Filed: May 29, 2014

Related U.S. Application Data
(63) Continuation of application No. PCT/EP2012/073453, filed on Nov. 23, 2012.

(51) Int. Cl. B60C 19/00

(52) U.S. Cl. CPC B60C 19/003
USPC 156/75; 152/154.1

(57) ABSTRACT

The invention relates to a pneumatic vehicle tire of a radial construction having a gas-tight inner layer, wherein on the side of the gas-tight inner layer that in the vulcanized and mounted pneumatic vehicle tire is directed towards the wheel rim there is at least one patch containing one or more liquid rubbers and one or more solid rubbers.

### CROSS-REFERENCE TO RELATED APPLICATIONS

This application is a continuation of International Patent Application No. PCT/EP2012/073453, filed Nov. 23, 2012, which claims priority to German Patent Application No. 10 2011 055 938.8, filed Dec. 1, 2011, the disclosures of which are incorporated herein by reference in their entireties and for all purposes.

### FIELD OF THE INVENTION

The invention relates to a pneumatic vehicle tire having improved imbalance.

### BACKGROUND OF THE RELATED ART

Manufacturers of pneumatic vehicle tires have to observe certain requirements in respect of tire uniformity and ensure that any deviations lie within an acceptable range, which is often laid down by law. Failure to meet these specific requirements causes the tire to be rejected, declared as imbalanced and scrapped rather than sold.

There are two types of imbalance: dynamic and static. Static imbalance is substantially the result of uneven material distribution in the vulcanized tire. As a consequence there is more weight at one or more specific local points in the tire than at other points. This can be caused inter alia by an uneven distribution of rubber material, which can occur right at the construction stage of the green tire or during vulcanization of the tire. The latter also applies to any uneven distribution of other tire components, such as reinforcing materials for example.

A previous option was to grind down such points in the tire manually.

However, grinding down such points in the tire does not adequately correct the static imbalance and at the same time it involves an additional cost during the production process, since it generally has to be carried out manually. In addition, the resulting abraded particles constitute a health hazard for the workers involved.

Another option for correcting imbalance is to attach additional weights to the wheel rim when fitting the tire. This is often undesirable to the vehicle owner, since it adversely affects the overall visual appearance of the tire and wheel rim.

Furthermore, patches can be introduced to correct imbalance in tires.

The term “patch” is now well-established in the tire industry. A patch is a molded element, such as for example a pad, a filler piece or a kind of plaster, which is applied to or introduced into the tire, preferably on the inner layer.

The presence of a patch in the tire is already known for example from WO2008/051229A1, WO2008/071361A1 or EP1985436A1. Here the patch is used to seal leaky points in the tire retrospectively or to prevent leaks while driving. In the latter case the patch is referred to as a sealant layer and in some cases is vulcanized with the tire. In order to obtain an optimal sealing effect these patches are based on polyurethane. The use of polyurethane increases the complexity of tire manufacture because additional raw materials have to be processed which as a rule do not form part of the various rubber compounds of a pneumatic vehicle tire.

### SUMMARY OF THE INVENTION

One aspect of the present invention is therefore to provide a pneumatic vehicle tire of a radial construction having a gas-tight inner layer, which is characterized in that imbalance is prevented or at least significantly reduced due to the presence of a patch and that the patch does not lead to an increase in complexity in tire manufacture.

This is achieved in that on the side of the gas-tight inner layer which in the vulcanized and mounted pneumatic vehicle tire is directed towards the wheel rim there is at least one patch, said patch containing one or more liquid rubbers and one or more solid rubbers.

The introduction of such a patch into the tire reduces or lastingly prevents an imbalance of the tire caused by uneven material distribution, which can occur during the tire manufacturing process. At the same time there is no increase in complexity during tire manufacture, since the patch contains one or more liquid rubbers and one or more solid rubbers which are preferably essential constituents of the rubber compounds from which the tire is usually constructed.

It is therefore essential to the invention that the patch of the pneumatic vehicle tire according to the invention contains a rubber composition comprising one or more liquid rubbers and one or more solid rubbers.

### DETAILED DESCRIPTION OF CERTAIN EMBODIMENTS OF THE INVENTION

Within the context of the present invention, the term liquid rubbers is understood to mean polymers which are free-flowing at 20° C. and which preferably have a glass transition temperature (T_{g}) of less than −20° C. and particularly preferably less than −40° C.

Unless otherwise defined, within the context of the present invention the glass transition temperature (T_{g}) is determined in accordance with DIN 53765 by differential scanning calorimetry (DSC) at a heating rate of 20° C./min using nitrogen as the purge gas.

The term “free-flowing” is known to the person skilled in the art and characterizes the flow characteristics of the polymers at 20° C. and under a normal pressure of 101325 Pa. Within the context of the present invention polymers which have a dynamic viscosity at 20° C. of 10,000 Pa·s or less are preferably characterized as “free-flowing”, wherein the dynamic viscosity is determined by the Brookfield method in accordance with DIN 53019 using a plate-plate system from Physica (gap 0.5 mm, shear rate 1 s⁻¹, plate diameter 25 mm).

The weight-average molecular weight (M_{w}) of the liquid rubbers of the present invention is preferably less than 80,000 g/mol. In a particularly preferred embodiment the weight-average molecular weight (M_{w}) of the liquid rubbers is between 400 g/mol and 40,000 g/mol.

Unless otherwise specified, within the context of the present invention the weight-average molecular weight (M_{w}) is determined by gel permeation chromatography (GPC) using polystyrene as the standard.

The solid rubbers have a significantly higher weight-average molecular weight (M_{w}) in comparison to the liquid rubbers, preferably above 100,000 g/mol. In particular the weight-average molecular weight (M_{w}) of the solid rubbers can be between 110,000 g/mol and 500,000 g/mol.

The liquid rubbers and solid rubbers of the present invention can be selected from a large number of structurally different polymers, for example from diene rubber compounds, polyisobutylenes, polybutenes, ethylene-propylene copolymers, acrylate rubbers, epichlorohydrin rubbers, silicone rubbers, fluorosilicone rubbers, chlorosulfonated polyethylenes or thermoplastic elastomers.

Suitable liquid rubbers are preferably selected from polybutadienes, in particular 1,4- and/or 1,2-polybutadienes, polybutenes, polyisoprenes, polyisobutylenes, stirene-butadiene copolymers or butadiene-acrylonitrile copolymers.

All of the above liquid rubbers can have one or more terminal and/or lateral functional groups, said groups preferably being selected from halogen groups, such as fluorine, chlorine, bromine and/or iodine, hydroxyl, amino, carboxyl, carboxylic acid anhydride and/or epoxy groups.

Within the context of the present invention polyisobutylenes are preferably used as liquid rubbers, since their use can impart good thermal stability and tackiness to the patch. Particularly preferred polyisobutylenes have a weight-average molecular weight (M_{w}) of between 400 g/mol and 40,000 g/mol.

The proportion of liquid rubbers in the total composition of the patch used according to the invention depends on the desired tackiness. The proportion of liquid rubbers in the total amount of the patch is preferably 5 to 50 wt. %, particularly preferably 7 to 40 wt. % and most preferably 10 to 30 wt. %.

In a preferred embodiment the proportion of polyisobutylene liquid rubbers in the total composition of the patch used according to the invention is 5 to 30 wt. %, particularly preferably 8 to 20 wt. % and most preferably 10 to 15 wt. %.

Mixtures of different liquid rubbers can of course also be used.

The patch of the present invention moreover contains one or more solid rubbers. In a preferred embodiment of the present invention the solid rubber is selected from diene rubber compounds. Alternatively, the solid rubber can also be selected from polyisobutylenes for example.

Within the meaning of the present invention the term “diene rubber compound”, often referred to as diene rubber, denotes crosslinked or uncrosslinked polymers or copolymers formed by polymerization or copolymerization of dienes. The glass transition temperature (T_{g}) of the diene rubber compounds is preferably less than 0° C., particularly preferably less than −10° C.

Conjugated dienes, such as 1,3-butadiene, 2-methyl buta-1,3-diene, unconjugated dienes, such as penta-1,4-diene, hexa-1,4-diene, hexa-1,5-diene, 2,5-dimethyl hexa-1,5-diene and octa-1,4-diene, cyclic dienes such as cyclopentadiene, cyclohexadienes, cyclooctadienes and/or dicyclopentadiene and/or alkenyl norbornenes, for example, can be used in the production of the diene rubber compounds. These or other dienes can be reacted alone or with further olefinic monomers such as for example acrylates, vinyl aromatic compounds such as stirene, aliphatic alkenes such as ethylene, propylene and/or butylene, and/or acrylonitrile by means of a suitable polymerization method to form the corresponding diene rubber compounds.

Within the context of the present invention preferred diene solid rubber compounds are selected from polybutadienes, in particular 1,4- and/or 1,2-polybutadienes, polyisoprenes, in particular 1,4- and 3,4-polyisoprenes, butyl rubbers (butadiene-isoprene copolymers), halobutyl rubbers, acrylonitrile-butadiene rubbers, polynorbornene, stirene-butadiene copolymers, stirene-isoprene-butadiene terpolymers, ethylene propylene diene copolymers or butadiene-acrylonitrile copolymers.

Examples of particularly suitable diene solid rubber compounds are butyl rubbers, i.e. butadiene-isoprene copolymers.

All of the above solid rubbers can have one or more terminal and/or lateral functional groups, said groups preferably being selected from halogen groups, such as fluorine, chlorine, bromine and/or iodine, hydroxyl, amino, carboxyl, carboxylic acid anhydride and/or epoxy groups.

Mixtures of different solid rubbers can of course also be used.

The proportion of solid rubbers in the total composition of the patch used according to the invention depends on the desired tackiness and thermal resistance. The proportion of one or more solid rubbers in the total amount of the patch is preferably 1 to 30 wt. %, particularly preferably 1.5 to 20 wt. % and most preferably 2 to 15 wt. %.

In a preferred embodiment the proportion of solid rubbers selected from diene rubber compounds in the total composition of the patch used according to the invention is 1 to 10 wt. %, particularly preferably 1.5 to 7 wt. % and most preferably 2 to 5 wt. %.

The patch of the present invention is preferably characterized in that it is self-adhesive, i.e., it can be applied to the gas-tight inner layer of the pneumatic vehicle tire under light contact pressure and remains in the desired position for the intended period of use. As a rule it is not necessary to heat the patch when positioning it on the gas-tight inner layer of the pneumatic vehicle tire, resulting in a particularly simple and cost-effective application.

The tackiness and the thermal resistance of the patch can be adjusted in a simple manner by the ratio of liquid rubber to solid rubber.

With regard to the application in a pneumatic vehicle tire, particularly good properties are achieved if, relative in each case to the total mass of the patch of the present invention, the total proportion of liquid rubber is 5 to 50 wt. % and the total proportion of solid rubber is 1 to 30 wt. %.

It is advantageous in particular if the total proportion of liquid rubber is 10 to 30 wt. % and the total proportion of solid rubber is 2 to 15 wt. %, relative in each case to the total mass of the patch.

The patch can also contain one or more additives if necessary. Suitable additives can be selected for example from the group of tackifying resins (tackifiers), adhesion promoters, plasticizers, fillers, stabilizers, rheology aids or toughening agents.

The proportion of one or more additives in the total mass of the patch according to the invention is preferably between 10 and 80 wt. %, particularly preferably between 20 and 70 wt. %.

Hydrocarbon resins, phenolic resins, terpene-phenolic resins, resorcinol resins or derivatives thereof, modified or unmodified rosin acids or esters (abietic acid derivatives), polyamines, polyaminoamides, anhydrides and anhydride-containing copolymers, for example, are suitable as tackifying resins (tackifiers) or adhesion promoters. The addition of polyepoxide resins in small amounts (<1 wt. %) can also improve adhesion in some cases. Typical tackifying resins (tackifiers) such as for example terpene-phenolic resins or rosin acid derivatives are preferably used in amounts between 5 and 15 wt. %, typical adhesion promoters such as polyamines, polyaminoamides or resorcinol derivatives are used in the range from 0.1 to 10 wt. %, all stated amounts relating to the total amount of the patch.

It is advantageous in particular for the patch to contain one or more fillers to reduce the shrinkage behavior and to further improve the thermal resistance. The fillers to be used can be selected from a large number of materials, with chalks, natural ground or precipitated calcium carbonates, calcium magnesium carbonates, silicates such as aluminum silicate, sulfates such as barium sulfate, barytes, graphite, carbon black and any mixtures thereof being preferred. Platelet-like fillers such as, for example, vermiculite, mica, talc or similar phyllosilicates are also suitable as fillers. The total proportion of fillers in the patch of the present invention can preferably be between 10 and 70 wt. % and particularly preferably between 30 and 60 wt. %.

Conventional stabilizers, such as for example sterically hindered phenols or amine derivatives, can be used to counter the thermal, thermo-oxidative or ozone degradation of the patches according to the invention, typical quantity ranges for these stabilizers being 0.1 to 5 wt. %.

The patch preferably contains at least carbon black as a filler.

In a particularly preferred embodiment the carbon black has an iodine value according to ASTM D 1510, also referred to as the iodine absorption value, greater than or equal to 75 g/kg and a DBP value greater than or equal to 80 cm³/100 g. The DBP value according to ASTM D 2414 determines the specific absorption value of a carbon black or a light-colored filler using dibutyl phthalate.

The use of such a carbon black type in the patch ensures the best possible compromise between abrasion resistance and heat build-up. It is preferable for only one carbon black type to be used here, but different carbon black types can also be used.

In a preferred embodiment the patch contains the following constituents, relative in each case to the total amount of the patch:
a) 1 to 30 wt. % of one or more solid rubbers;
b) 5 to 50 wt. % of one or more liquid rubbers; and
c) 20 to 80 wt. % of one or more additives.

In a further preferred embodiment the patch contains the following constituents, relative in each case to the total amount of the patch:
a) 1 to 30 wt. % of one or more solid rubbers;
b) 5 to 50 wt. % of one or more liquid rubbers;
c) 10 to 50 wt. % of one or more fillers, including, relative to the total amount of the patch, 2 to 20 wt. % of carbon black; and
d) 10 to 30 wt. % of one or more further additives differing from component c).

The patch used in the present invention can consist of one, two or more layers. It is advantageous here for the layer of the patch that is in direct contact with the gas-tight inner layer of the pneumatic vehicle tire according to the invention to be self-adhesive, since in this way, as described above, a particularly simple and cost-effective application of the patch is achieved.

If the patch is of a two-layer or multi-layer construction, the layer of the patch that is in direct contact with the gas-tight inner layer of the pneumatic vehicle tire according to the invention has higher adhesive properties, i.e., a higher adhesive strength, than the outer layer of the patch. The “outer layer” is understood to be the layer of the patch furthest away from the inner side of the pneumatic vehicle tire according to the invention. The outer layer of the patch preferably has a similar adhesive strength and appearance to the inner layer of the pneumatic vehicle tire, thereby preventing the presence of the patch from being visually apparent.

If the patch is of a two-layer or multi-layer construction it is therefore absolutely necessary for at least the layer that is in direct contact with the gas-tight inner layer of the pneumatic vehicle tire according to the invention to comprise one or more liquid rubbers and one or more solid rubbers of the present invention. The further layer(s) can likewise contain one or more liquid rubbers and/or one or more solid rubbers, it being advantageous for the outer layer to contain only one or more solid rubbers of the present invention. It is preferable in particular for the outer layer to comprise only polyisobutylene as the solid rubber, said polyisobutylene preferably having a weight-average molecular weight of between 110,000 g/mol and 500,000 g/mol.

In order to achieve low material usage and high positioning accuracy over the period of use, it is advantageous for the patch of the present invention to have a density of at least 1.6 g/cm³.

Within the context of the present invention the density of the patch is determined by means of the buoyancy method, by weighing the patch at 23° C. in air and in distilled water. The density of the patch is then calculated by the following formula:

$$Density = \frac{\frac{m [ air ]}{( m [ air ] - m [ water ] )}}{density [ water , 23 ° C . ]}$$

the value 0.99756 g/cm³ being used as the water density at 23° C.

The present invention also provides a method for producing a pneumatic vehicle tire according to the invention, wherein after vulcanization of the pneumatic vehicle tire at least one patch containing one or more liquid rubbers and one or more solid rubbers is applied to the side of the gas-tight inner layer that in the vulcanized and mounted pneumatic vehicle tire is directed towards the wheel rim. All embodiments of the patch disclosed within the context of the pneumatic vehicle tire according to the invention also apply in an analogous manner to the use thereof in the above method.

The patch can be introduced into the pneumatic vehicle tire by the following method:

After vulcanization of the pneumatic vehicle tire the static imbalance is determined and the corresponding tire is removed from the production line. Then the point or optionally a plurality of points having an uneven material distribution is determined. Starting from these imbalance points, a patch is applied in a position 180° C. away from each of these imbalance points. The weight of the patch is in each case adequate to ensure that the tire uniformity is then within an acceptable range. It is advantageous in particular for the patch to have a density of at least 1.6 g/cm³.

The patch can be self-adhesive or it can be applied to the inner layer using a suitable adhesive. The patch is generally applied at 5° C. to 40° C., preferably at 15° C. to 35° C. and most particularly preferably at 20° C. to 25° C., wherein the inner layer of the tire should be cleaned first to remove any residues from the vulcanizing mold. Cleaning with water is ideally sufficient, i.e., as a general rule no inorganic or organic cleaning agents and/or solvents presenting an environmental and/or health risk are needed.

The present invention also provides the use of the patch used according to the invention to reduce or eliminate the imbalance of pneumatic vehicle tires. All embodiments of the patch disclosed within the context of the pneumatic vehicle tire according to the invention also apply in an analogous manner to the above use thereof.

What is claimed is:

1. A pneumatic vehicle tire of a radial construction having a gas-tight inner layer, wherein on the side of the gas-tight inner layer that in the pneumatic vehicle tire, when the pneumatic vehicle tire is mounted on a wheel rim, is directed towards the wheel rim there is at least one patch, said patch comprising one or more liquid rubbers and one or more solid rubbers.

2. The pneumatic vehicle tire according to claim 1, wherein the solid rubber and the liquid rubber are selected from the group consisting of diene rubber compounds, polyisobutylenes, polybutenes, ethylene-propylene copolymers, acrylate rubbers, epichlorohydrin rubbers, silicone rubbers, fluorosilicone rubbers, chlorosulfonated polyethylenes and thermoplastic elastomers.

3. The pneumatic vehicle tire according to claim 1, wherein the liquid rubber is selected from polybutadienes.

4. The pneumatic vehicle tire according to claim 1, wherein the liquid rubber has a weight-average molecular weight (M_{w}) of between 400 g/mol and 40,000 g/mol.

5. The pneumatic vehicle tire according to claim 1, wherein the proportion of liquid rubbers with respect to the total amount of the patch is 5 to 50 wt. %.

6. The pneumatic vehicle tire according to claim 1, wherein the solid rubber is selected from diene rubber compounds, in particular from butyl rubbers.

7. The pneumatic vehicle tire according to claim 1, wherein the solid rubber is selected from butyl rubbers.

8. The pneumatic vehicle tire according to claim 1, wherein the solid rubber has a weight-average molecular weight (M_{w}) of between 110,000 g/mol and 500,000 g/mol.

9. The pneumatic vehicle tire according to claim 1, wherein the proportion of solid rubbers with respect to the total amount of the patch is 1 to 30 wt. %.

10. The pneumatic vehicle tire according to claim 1, wherein, relative to the total mass of the patch, the total proportion of liquid rubber is 10 to 30 wt. % and the total proportion of solid rubber is 2 to 15 wt. %.

11. The pneumatic vehicle tire according to claim 1, wherein the patch is additionally comprised of at least one filler.

12. The pneumatic vehicle tire according to claim 11, wherein the at least one filler includes carbon black.

13. The pneumatic vehicle tire according to claim 1, wherein the patch has a density of at least 1.6 g/cm³.

14. The pneumatic vehicle tire according to claim 1, wherein the patch consists of one layer.

15. The pneumatic vehicle tire according to claim 1, wherein the patch comprises two or more layers.

16. A method of reducing or eliminating the imbalance of a pneumatic vehicle tire, comprising applying a patch comprising one or more liquid rubbers and one or more solid rubbers to the pneumatic vehicle tire.

17. A method for producing a pneumatic vehicle tire having a gas-tight inner layer, wherein after vulcanization of the pneumatic vehicle tire at least one patch comprising one or more liquid rubbers and one or more solid rubbers is applied to the side of the gas-tight inner layer that in the pneumatic vehicle tire, when the pneumatic vehicle tire is mounted on a wheel rim, is directed towards the wheel rim.

18. The method according to claim 17, wherein the patch is applied at a temperature from 5° C. to 40° C.

19. The method according to claim 17, wherein the patch is applied at a temperature from 15° C. to 35° C.

20. The method according to claim 17, wherein the patch is applied at a temperature from 20° C. to 25° C.
